(19) United States
(12) Patent Application Publication
(10) Pub. No.: US 2010/0224062 A1
(43) Pub. Date: Sep. 9, 2010

(54) CAUSTIC-ASSISTED SEAWATER SCRUBBER SYSTEM

(76) Inventors: Ronald Patterson, San Diego, CA (US); Andrew J. Olds, San Diego, CA (US)

Correspondence Address: Delaney IP, P.O. Box 9542, Rancho Santa Fe, CA, 92067, US

(21) Appl. No.: 12/398,947

(22) Filed: Mar. 5, 2009

(51) Int. Cl. B01D 53/50; B01D 53/96

(52) U.S. Cl. 95/158; 96/235

(57) ABSTRACT

The system uses seawater to remove sulfur dioxide from shipboard diesel exhaust gases. Structurally, the system includes a single-stage countercurrent scrubber with top and bottom ends. During operation, diesel exhaust gases are introduced into the bottom end of the scrubber and flow to the top end of the scrubber. Further, seawater is fed into the top end of the scrubber and falls to the bottom end while absorbing sulfur dioxide from the diesel exhaust gases. Thereafter, the exhaust gases exit the scrubber, substantially free of sulfur dioxide. Further, the extremely acidic effluent seawater exits the scrubber and is treated with caustic. As a result, the caustic neutralizes the seawater. Also, dissolved carbon dioxide may be removed from the effluent seawater to reduce the amount of caustic required for neutralization. In addition, an oxidizer may be used to reduce the chemical oxygen demand of the effluent seawater.

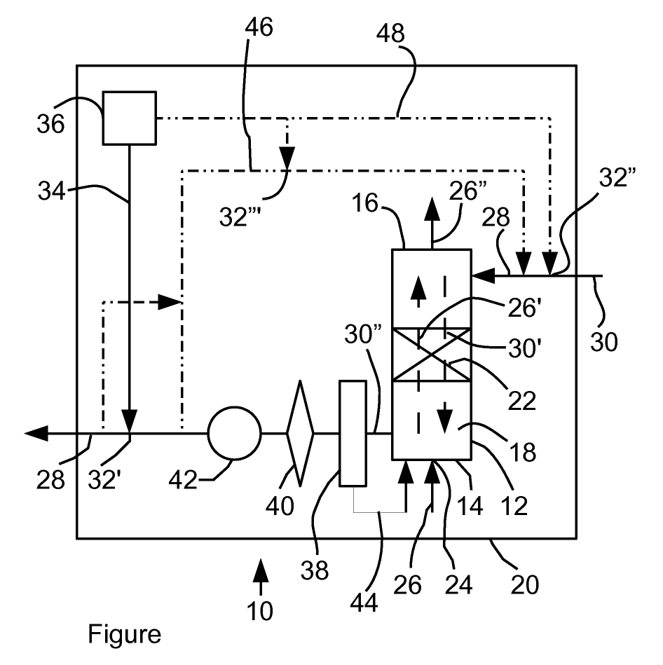

### CROSS-REFERENCE TO RELATED APPLICATIONS

The present application is related to the co-pending application entitled “Shipboard Vessel Having a Vertically Aligned Scrubber and Process Component”, application Ser. No. ______, filed on Mar. 5, 2009 and incorporated herein by reference in its entirety.

### FIELD OF THE INVENTION

The present invention pertains generally to a shipboard air pollution abatement system. More particularly, the present invention pertains to a scrubbing system that eliminates sulfur dioxide from exhaust gases. The present invention is particularly, but not exclusively, useful as a caustic-assisted seawater scrubber system that removes sulfur dioxide from shipboard diesel exhaust gases while discharging environmentally safe effluent seawater into the sea.

### BACKGROUND OF THE INVENTION

As is well known, the combustion of hydrocarbon-containing fuels, such as diesel, results in exhaust gases containing sulfur compounds including sulfur dioxide. Further, the presence of sulfur dioxide in the atmosphere has been linked to the formation of acid rain. Due to the ecological damage resulting from acid rain, the United States Environmental Protection Agency has set standards for land-based power plants to prevent the emission of sulfur dioxide.

While land-based plants have taken a variety of methods to reduce or eliminate the emission of sulfur dioxide, many of these are inappropriate for shipboard plants. In fact, the land-based methods are often inapplicable to shipboard plants.

In light of the above, it is an object of the present invention to provide a system and method for scrubbing shipboard exhaust gases with seawater. It is another object of the present invention to provide a shipboard scrubbing system that utilizes caustic to reduce the sulfur dioxide load on the seawater solvent for discharge into the sea. Another object of the present invention is to provide a system for first eliminating sulfur dioxide from exhaust gases and for thereafter raising the pH of the solvent seawater to acceptable levels for discharge into the sea. Still another object of the present invention is provide a sulfur dioxide scrubbing system that oxidizes effluent seawater to reduce its chemical oxygen demand level. Another object of the present invention is to provide a sulfur dioxide scrubbing system that degasifies effluent seawater to reduce the amount of caustic necessary to raise the pH of the seawater to a level acceptable for discharge into the sea. Another object of the present invention is to provide for return of the gas removed by the degasifier to the bottom end of the scrubber. Still another object of the present invention is to provide a sulfur dioxide scrubbing system that removes ash and oil from the effluent seawater for discharge into the sea. Yet another object of the present invention is to provide a caustic-assisted seawater scrubber system for removing sulfur dioxide from shipboard exhaust gases and a method for operating the system which are easy to use, relatively simple to implement, and comparatively cost effective.

### SUMMARY OF THE INVENTION

The present invention is directed to a scrubber system for removing sulfur dioxide from shipboard exhaust gases. Importantly, the system uses seawater as a solvent to remove sulfur dioxide from exhaust gases, and discharges effluent seawater from the ship at an acceptable pH level. To do so, the system first operates the scrubber at an extremely low pH, i.e., under 4.5, and in certain embodiments, under 3.5, under 3.0, or at about 2.5. As a result, in those embodiments, at least 50%, and typically about 90% of the alkalinity of the seawater is consumed during the scrubbing process. In this manner, a lower volume of seawater is needed for the removal of sulfur dioxide during scrubbing. Second, the system utilizes caustic chemicals to neutralize the very acidic effluent seawater after the scrubbing process to allow for discharge into the sea.

Structurally, the system includes a single stage scrubber with a bottom end and a top end. At the bottom end, an inlet introduces the diesel exhaust gases into the scrubber. Also, a conduit is connected to the scrubber to feed seawater into the top end of the scrubber and to remove effluent seawater from the bottom end of the scrubber. As the seawater falls from the top end to the bottom end of the scrubber, it contacts the rising exhaust gases and absorbs the sulfur dioxide. Specifically, the sulfur dioxide is absorbed from the exhaust gases by the seawater in a countercurrent scrubber mechanism. Within the effluent seawater, alkalines such as hydroxyl and carboxyl convert the sulfur dioxide to sulfite and sulfur trioxide. As stated above, the scrubber is designed to result in a pH drop of about 6.5-7.8 (seawater) to less than 4.5, often less than 3.5, and about 2.5 (effluent seawater).

Thereafter, the scrubbed exhaust gases are released and the effluent seawater exits the scrubber. As the effluent seawater exits the scrubber, it is extremely acidic due to the conversion of the sulfur dioxide to sulfite and sulfur trioxide. In order to raise the pH of the effluent seawater to an acceptable level, such as a pH of about 6.5, an appropriate amount of caustic is added to it. Then the effluent seawater is discharged into the sea. As a result, the ship is able to use the plentiful supply of seawater without requiring storage of the solvent seawater or storage of the effluent seawater. Further, in the present system, a relatively low amount of seawater, and a relatively low volumetric flow rate of seawater through the scrubber (such as less than 7500 gallons/minute, less than 5000 gal/min or even less than 2500 gal/min for 97% removal of sulfur dioxide from the exhaust gases, and about 1800 gal/min for 75% removal) is needed for effective removal of sulfur dioxide from the exhaust gases.

In certain embodiments, the system may provide for improved performance through further processing of the effluent seawater. Specifically, the effluent seawater may contain dissolved carbon dioxide. Because dissolved carbon dioxide is acidic, the system provides for the removal of the carbon dioxide from the effluent seawater by a degasifier before the caustic is added. As a result, the amount of caustic needed for neutralization of the seawater is reduced. Also, along with the carbon dioxide, some sulfur dioxide will be removed from the effluent seawater by the degasifier. Therefore, the system feeds the gas removed by the degasifier back into the bottom of the scrubber.

Also, in certain embodiments, the effluent seawater may be oxidized in order to reduce its chemical oxygen demand. Specifically, the scrubbing process converts sulfur dioxide (SO₂) to sulfur trioxide (SO₃). However, the fully oxidized form of sulfur is sulfur oxide (SO₄). Therefore, the effluent seawater has a demand for extra oxygen, i.e., its chemical oxygen demand. By using a permanganate bed, oxidizing fluids, or other oxidizing media, the SO₃ converts to SO₄ and the demand is reduced or eliminated.

Further, the system may provide a separator for removing ash and oil from the effluent seawater. In certain embodiments, the separator will be a hydroclone centrifugal separator. This is a static closed-vessel device that applies centrifugal force to the effluent seawater to promote the separation of heavy and light components. Due to the operation of the degasifier, oxidizing mechanism and separator, the need for caustic may be decreased substantially along with the amount of caustic stored and carried by the ship

### BRIEF DESCRIPTION OF THE DRAWING

The novel features of this invention, as well as the invention itself, both as to its structure and its operation, will be best understood from the accompanying FIGURE, taken in conjunction with the accompanying description, in which similar reference characters refer to similar parts, and in which the FIGURE is a plan view of a caustic-assisted seawater scrubber system for removing sulfur dioxide from shipboard diesel exhaust gases.

### DESCRIPTION OF THE PREFERRED EMBODIMENTS

Referring to the FIGURE, a scrubbing system for removing sulfur dioxide from shipboard diesel exhaust gases is shown and generally designated 10. As shown in the FIGURE, the system 10 comprises a single-stage countercurrent scrubber 12 having a bottom end 14 and a top end 16 and defining a chamber 18. As shown, the scrubber 12 is mounted on a ship 20.

Within the chamber 18 of the scrubber 12, is a countercurrent vapor-liquid contact mechanism 22. For the system, the mechanism 22 may be tray-type, packed bed, direct spray or other arrangement for providing countercurrent vapor-liquid contact. As shown, the scrubber 12 is provided with an inlet 24 at its bottom end 14 for introducing exhaust gases 26 including sulfur dioxide into the chamber 18. For ships, combustion of the standard diesel fuel results in exhaust gases 26 containing about 2.9 or 3.0% sulfur.

At its top end 16, the scrubber 12 is in fluid communication with a conduit 28 for feeding seawater 30 into the chamber 18. As is typical for vapor-liquid contact scrubbers, the liquid seawater 30′ falls from the top end 16 to the bottom end 14 while contacting the exhaust gases 26′ rising through the chamber 18. During this contact, the seawater 30′ absorbs the sulfur dioxide from the exhaust gases 26, and fully scrubbed exhaust gases 26″ are released by the scrubber 12. In certain embodiments, 97% of the sulfur dioxide is removed from the exhaust gases 26″ in a single pass, as opposed to the single pass norm of about 70% for contemporary shipboard systems.

As further shown in the FIGURE, the conduit 28 is in fluid communication with the bottom end 14 of the scrubber 12 to remove the effluent seawater 30″. For purposes of the present invention, the conduit 28 is also in fluid communication with a port 32′ for adding caustic 34 from a caustic tank 36 to neutralize the acidic effluent seawater 30. Preferably, the caustic 34 is sodium hydroxide, potassium hydroxide, sodium carbonate, calcium carbonate, calcium hydroxide, ammonium hydroxide, limestone or a similar material. After the effluent seawater 30″ has reached an acceptable pH level, it is discharged from the ship 20.

While the described system 10 operates sufficiently to enable the shipboard use of a seawater scrubber 12, it may further include a degasifier 38, an oxidizer 40, and a separator 42 in fluid communication with the conduit 28. As a result of processing, the effluent seawater 30″ may contain dissolved carbon dioxide, which is acidic. In order to reduce the amount of caustic 34 required for effective treatment of the effluent seawater 30″, the degasifier 38 removes dissolved carbon dioxide from the effluent seawater 30″ and facilitates the caustic-addition neutralization process. Further, the degasifier 40 may also remove some sulfur dioxide from the effluent seawater 30″, therefore, the system 10 provides for feeding the removed gas back into the bottom end 14 of the scrubber 12 through a conduit 44.

For the system 10, the oxidizer 40 is used to reduce the chemical oxygen demand of the seawater 30″. Specifically, the effluent seawater 30″ includes sulfur trioxide, which is a partially oxidized form of sulfur. In order to convert the sulfur trioxide (SO₃) to the fully oxidized sulfur oxide (SO₄), an oxygen is required, and is provided by the oxidizer 40. As a result, the chemical oxygen demand of the effluent seawater 30″ is reduced. The oxidizer 40 may be a physical oxidizer like a permanganate bed or a liquid oxidizer like peroxide, ozone or others. For liquid oxidizers, the oxygen demand is decreased while no additional salinity is added to the effluent seawater 30″.

In certain embodiments, the separator 42 is a hydroclone centrifugal separator which first removes particulate, such as ash, from the effluent seawater 30″. Later, in the same process, the separator 42 removes oils from the effluent seawater 30″. As a result, the effluent seawater 30″ is more safely prepared for discharge into the sea.

During operation of the system 10, the seawater 30 fed into the top end 16 of the scrubber 12 will typically have an alkalinity in the range of about 900 to about 2400 micromoles per liter with a pH of above 5.0. Generally, the seawater 30 at the top end 16 of the scrubber 12 must be at a pH of higher than the theoretical removal efficiency for the sulfur dioxide in the exhaust gases. If the pH is too low, the last of the sulfur dioxide will not absorb into the seawater 30′. Of course, with fresh seawater 30 entering the scrubber 12, the pH is generally sufficiently high. As the seawater 30′ absorbs the sulfur dioxide from the exhaust gases 26′, it will convert the sulfur dioxide into sulfite and sulfur trioxide. This absorption and conversion process is driven principally by water loading, gas loading, temperature and pH. While seawater is an abundant, low cost source of alkalinity and an absorbent solvent, its use is limited by the regulated pH of the seawater discharged back into the sea. In the past, academic and commercial sources have operated shipboard seawater scrubbers at a pH of 6.0-7.0, typically at 6.5. For the present shipboard system 10, the effluent seawater 30″ exiting the scrubber 12 will have a pH of less than 4.5, less than 3.5, less than 3.0, or about 2.5 or 2.0. However, the discharge pH may be required to be about 6.5.

As explained above, in order to obtain an acceptable discharge pH, the system 10 provides for the addition of caustic 34 to the effluent seawater 30″. As a result, the added caustic 34 can make up for the load of the sulfur dioxide and the quantity of seawater 30 required to remove the sulfur dioxide while still meeting the discharge pH requirements.

While one embodiment of the system 10 has been described above, the Figure discloses several other embodiments. Specifically, as described above, the seawater 30 makes a single pass through the scrubber 12. However, the seawater 30 may be partially recirculated if desired. As shown, a recirculation path 46 allows some of the effluent seawater 30″ to be recycled to be fed into the scrubber 12 by the conduit 28.

Further, as described above, the caustic 34 is added to the seawater 30 at a port 32′ downstream of the scrubber 12. Alternatively or additionally, the caustic 34 may be added to the seawater 30 at a port 32″ upstream of the scrubber 12, and/or to the recirculation path 42 at a port 32′″. While a single tank 36 is illustrated, the system 10 may include a plurality of tanks 36 for providing caustic at different ports 32.

While the particular Caustic-Assisted Seawater Scrubber System as herein shown and disclosed in detail is fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A system for removing sulfur dioxide from diesel exhaust gases produced on a ship comprising:
a scrubber having a bottom end and a top end;
an inlet for introducing the diesel exhaust gases into the bottom end of the scrubber, with the diesel exhaust gases flowing to the top end of the scrubber;
a conduit for feeding seawater into the top end of the scrubber to cause the seawater to fall from the top end to the bottom end while absorbing sulfur dioxide from the diesel exhaust gases, and for thereafter discharging effluent seawater into the sea; and
a port for adding caustic into the conduit to neutralize the effluent seawater before discharging it into the sea.

2. The system as recited in claim 1 further comprising a separator in fluid communication with the conduit downstream of the scrubber for removing particulate and oils from the effluent seawater.

3. The system as recited in claim 2 wherein the separator is a hydroclone centrifugal separator.

4. The system as recited in claim 2 further comprising a degasifier for removing dissolved carbon dioxide from the effluent seawater downstream of the scrubber, wherein the removal of carbon dioxide from the effluent seawater reduces the amount of caustic required for neutralizing the effluent seawater.

5. The system as recited in claim 4 wherein gas removed from the effluent seawater by the degasifier is fed back into the bottom end of the scrubber.

6. The system as recited in claim 4 further comprising an oxidizer to reduce a chemical oxygen demand of the effluent seawater downstream of the scrubber.

7. The system as recited in claim 1 wherein the caustic is selected from the group consisting of sodium hydroxide, potassium hydroxide, sodium carbonate, calcium carbonate, calcium hydroxide, ammonium hydroxide, and limestone.

8. The system as recited in claim 1 wherein the effluent seawater is discharged into the sea with a pH of about 6.5.

9. The system as recited in claim 1 wherein the pH of the seawater is lowered to about 2.5 during the scrubbing process.

10. A method for for removing sulfur dioxide from diesel exhaust gases produced on a ship comprising the steps of:
providing a scrubber having a bottom end and a top end;
introducing the diesel exhaust gases into the bottom end of the scrubber, with the diesel exhaust gases flowing to the top end of the scrubber;
feeding seawater into the top end of the scrubber to cause the seawater to fall from the top end to the bottom end while absorbing sulfur dioxide from the diesel exhaust gases;
flowing effluent seawater out from the bottom end of the scrubber;
removing gas from the effluent seawater with a degasifier;
returning the removed gas to the bottom end of the scrubber;
separating particulate and oils from the effluent seawater;
adding caustic to the effluent seawater for neutralization; and
discharging the effluent seawater into the sea.

11. The method as recited in claim 10 further comprising the step of oxidizing the effluent seawater to reduce its chemical oxygen demand.

12. The method as recited in claim 10 wherein the pH of the seawater falls to about 2.5 as a result of absorbing the sulfur dioxide from the diesel exhaust gases.

13. A method for for removing sulfur dioxide from diesel exhaust gases produced on a ship comprising the steps of:
providing a scrubber having a bottom end and a top end;
introducing the diesel exhaust gases into the bottom end of the scrubber, with the diesel exhaust gases flowing to the top end of the scrubber;
feeding seawater into the top end of the scrubber to cause the seawater to fall from the top end to the bottom end while absorbing sulfur dioxide from the diesel exhaust gases;
adding caustic to the seawater to neutralize the seawater; and
discharging effluent seawater into the sea.

14. The method as recited in claim 13 wherein the adding step is performed downstream of the scrubber.

15. The method as recited in claim 13 further comprising the step of separating particulate and oils from the seawater downstream of the scrubber.

16. The method as recited in claim 15 further comprising the step of removing carbon dioxide and other gases from the seawater downstream of the scrubber to reduce the amount of caustic required for neutralizing the seawater.

17. The method as recited in claim 16 further comprising the step of returning the carbon dioxide and other gases removed from the seawater to the bottom end of the scrubber.

18. The method as recited in claim 17 further comprising the step of oxidizing the seawater downstream of the scrubber to reduce a chemical oxygen demand of the seawater.

19. The method as recited in claim 18 wherein the pH of the seawater is lowered to about 2.5 while in the scrubber.

20. The method as recited in claim 13 wherein the pH of the seawater is lowered to about 2.5 while in the scrubber.
